(19) United States
(12) Patent Application Publication
(10) Pub. No.: US 2026/0131615 A1
(43) Pub. Date: May 14, 2026

(54) VEHICLE SUSPENSION

(71) Applicant: SUBARU CORPORATION, Tokyo (JP)

(72) Inventors: Shunsuke MATSUO, Tokyo (JP); Koichi UCHIKAWA, Tokyo (JP); Manabu TONOZAKI, Tokyo (JP)

(21) Appl. No.: 19/367,422

(22) Filed: Oct. 23, 2025

(30) Foreign Application Priority Data
Nov. 12, 2024 (JP) 2024-197154

(51) Int. Cl. B60G 21/055

(52) U.S. Cl. CPC B60G 21/0555; B60G 2400/0511; B60G 2400/0523; B60G 2400/104; B60G 2400/41

(57) ABSTRACT

A vehicle suspension includes: suspension devices configured to support left and right wheels; a stabilizer bar configured to couple the suspension devices via respective stabilizer links; a stabilizer sliding mechanism configured to slide the stabilizer bar; and a controller configured to control driving of a drive unit of the stabilizer sliding mechanism. The controller is configured to displace a roll axis by sliding the stabilizer bar via the stabilizer sliding mechanism during cornering of a vehicle.

### CROSS-REFERENCE TO RELATED APPLICATIONS

The present application claims priority from Japanese Patent Application No. 2024-197154 filed on November 12, 2024, the entire contents of which are hereby incorporated by reference.

### BACKGROUND

The disclosure relates to a vehicle suspension.

A vehicle equipped with an independent suspension device is provided with a stabilizer device. The stabilizer device includes a stabilizer bar. The stabilizer bar serves as a torsion spring.

For example, as disclosed in Japanese Unexamined Patent Application Publication (JP-A) No. 2023-134849, the ends of the stabilizer bar are coupled, via stabilizer links, to stabilizer brackets provided on struts of right and left suspension devices.

When there is a difference in stroke amount between the right and left suspension devices during cornering of the vehicle, torsional stress is generated in the stabilizer bar. Then, restoring forces (reaction forces) for returning the torsion act on the right and left suspension devices so that the stroke amounts of the right and left suspension devices are equal. As a result, the inclination (rolling) of a vehicle body toward the wheel on the outside of a turn (hereinbelow, the outside wheel) is suppressed, and the stability of the vehicle body during cornering is improved.

The difference in stroke amount between the left and right suspension devices during cornering is the difference between the bump amount (contraction) on the outside wheel side and the rebound amount (expansion) on the inside wheel (i.e., the wheel on the inside of a turn) side. Typically, the bump amount and the rebound amount are substantially symmetrical. Hence, the center of rolling (roll axis) generated in the vehicle body is not changed by the twist of the stabilizer bar, and the roll axis is located at the center of the vehicle body in the vehicle width direction. However, depending on the type of vehicle, it may be possible to ensure stability during traveling by making the bump stroke amount on the outside wheel side and the rebound stroke amount on the inside wheel side during traveling asymmetric.

For example, when the roll axis is displaced from the center in the vehicle body width direction toward the center of a turn (the inside wheel side), the rebound amount on the inside wheel side is reduced, and the bump amount on the outside wheel side is relatively increased. Thus, high response performance can be obtained.

In contrast, when the roll axis is changed from the center in the vehicle body width direction to the outside wheel side, the rebound amount on the inside wheel side increases, and the bump stroke amount on the outside wheel side is relatively reduced. As a result, the steering becomes slightly understeer, making the driver feel that the vehicle speed is excessive.

Some of the suspension devices as disclosed in JP-A No. 2023-134849 incorporate rebound springs and helper springs. The rebound springs restrict the extension of shock absorbers by means of a repulsive force.

The rebound springs do not restrict the compression of the shock absorbers. The helper springs are mounted above or below main springs to ensure the extension-side stroke of the main springs.

If the stroke amount of the rebound springs is reduced or the stroke amount of the helper springs is increased, the stroke amounts of the left and right suspension devices become asymmetric during cornering. As a result, the roll axis can be displaced to one side from the center in the vehicle width direction.

### SUMMARY

An aspect of the disclosure provides a vehicle suspension including: suspension devices configured to support left and right wheels; a stabilizer bar configured to couple the suspension devices via respective stabilizer links; a stabilizer sliding mechanism configured to slide the stabilizer bar; and a controller configured to control driving of a drive unit of the stabilizer sliding mechanism. The controller is configured to displace a roll axis by sliding the stabilizer bar via the stabilizer sliding mechanism during cornering of a vehicle.

An aspect of the disclosure provides a vehicle suspension including: suspension devices configured to support left and right wheels; a stabilizer bar configured to couple the suspension devices via respective stabilizer links; a stabilizer sliding mechanism configured to slide the stabilizer bar; and circuitry configured to control driving of a drive unit of the stabilizer sliding mechanism. The circuitry is configured to displace a roll axis by sliding the stabilizer bar via the stabilizer sliding mechanism during cornering of a vehicle.

### BRIEF DESCRIPTION OF THE DRAWINGS

The accompanying drawings are included to provide a further understanding of the disclosure and are incorporated in and constitute a part of this specification. The drawings illustrate an embodiment and, together with the specification, serve to describe the principles of the disclosure.

FIG. 1 is a front view illustrating a schematic configuration of a suspension;

FIG. 2 is a cross-sectional view of a relevant part of a stabilizer sliding mechanism;

FIG. 3 illustrates a schematic configuration of a control unit;

FIG. 4 is a plan view illustrating a stabilizer device when an auto mode switch is OFF;

FIG. 5 is a plan view illustrating the stabilizer device in a state in which a roll axis is displaced from the center in the vehicle width direction to the inside wheel side;

FIG. 6 is a plan view illustrating the stabilizer device in a state in which the roll axis is displaced from the center in the vehicle width direction to the outside wheel side;

FIG. 7 is a front view illustrating a vehicle body roll during cornering when the auto mode switch is OFF;

FIG. 8 is a front view illustrating a vehicle body roll in a state in which the roll axis is displaced from the center in the vehicle width direction to the inside wheel side; and

FIG. 9 is a front view illustrating a vehicle body roll in a state in which the roll axis is displaced from the center in the vehicle width direction to the outside wheel side.

### DETAILED DESCRIPTION

Rebound springs and helper springs are devices to be added to suspension devices. Adding these devices to existing suspension devices is subject to dimensional constraints. The rebound springs and the helper springs must maintain their original functions. In particular, when both left and right wheels bounce (stroke) at the same time, the reaction forces of the rebound springs act on main springs, which readily affects ride comfort.

Hence, there is a limit in displacing the roll axis from the center in the vehicle width direction to one side by adding devices, such as rebound springs and helper springs, to the existing suspension devices.

It is desirable to provide a vehicle suspension capable of easily making the rebound stroke amount on the inner wheel side and the bump stroke amount on the outer wheel side during traveling asymmetric according to the characteristics of the vehicle type.

In the following, an embodiment of the disclosure is described in detail with reference to the accompanying drawings. Note that the following description is directed to an illustrative example of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiment which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same numerals to avoid any redundant description.

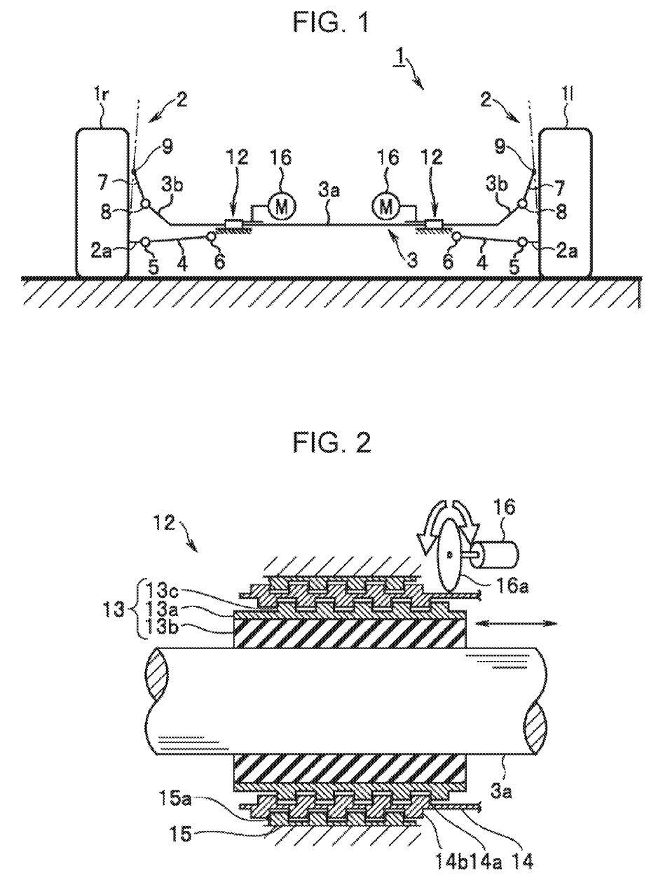

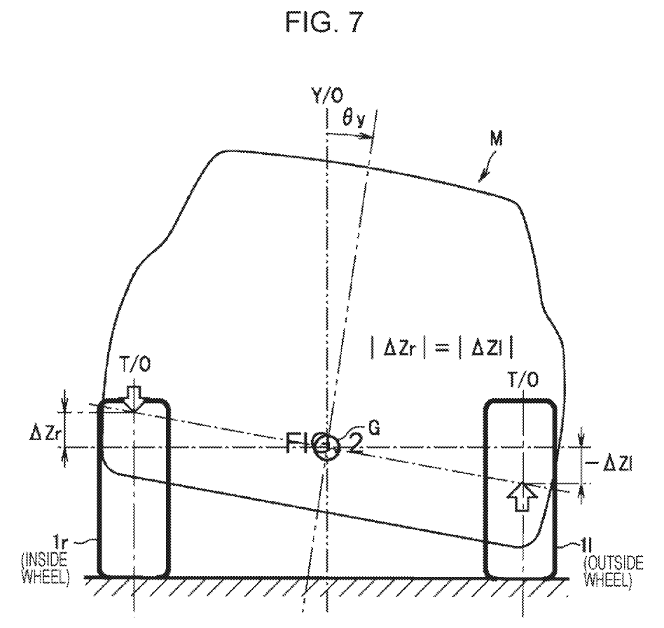

FIG. 1 illustrates a suspension 1 of a vehicle M (see FIGS. 7 to 9). The suspension 1 can be disposed not only on left and right front wheels (steering wheels) but also on left and right rear wheels. Hereinafter, a case where the suspension 1 is disposed on the left and right front wheels (steering wheels) 1l and 1r will be described as an example.

The suspension 1 includes suspension devices 2 and a stabilizer device 3. Each suspension device 2 includes a steering knuckle 2a. The steering knuckle 2a rotatably supports an axle to which the left and right wheels 1l and 1r are fixed. Each suspension device 2 also includes a suspension body (not illustrated). The suspension body is, for example, a strut suspension. A strut portion of the suspension body is fixed to the steering knuckle 2a.

The lower part of the steering knuckle 2a is coupled to an outer side of a lower arm 4 in the vehicle width direction via a ball joint 5. An inner side of the lower arm 4 in the vehicle width direction is coupled to the vehicle body via a rubber bush 6.

The stabilizer device 3 includes a straight rod-shaped stabilizer bar 3a having a torsion spring property. The stabilizer bar 3a is disposed in parallel with a steering gear box provided in a steering mechanism (not illustrated). Arm portions 3b are formed by bending at both ends of the stabilizer bar 3a.

Each arm portion 3b is coupled to one end of a stabilizer link 7 via a ball joint 8. The other end of the stabilizer link 7 is coupled to the strut portion of the suspension body via a coupling 9, such as a ball joint or a bush.

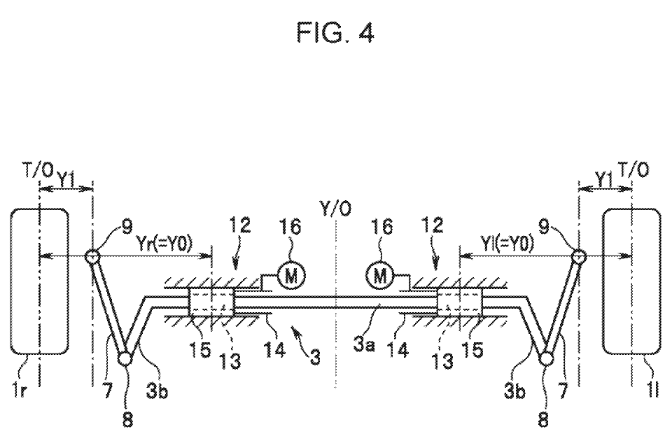

As illustrated in FIG. 4, when the center of the stabilizer bar 3a in the vehicle width direction (hereinafter referred to as the "center of the stabilizer bar 3a") is at the center (Y/O) of the vehicle M in the vehicle width direction, i.e., at a neutral position, a pair of stabilizer sliding mechanisms 12 are disposed at a predetermined distance from each other at symmetrical positions with respect to the center (Y/O) of the stabilizer bar 3a. The stabilizer sliding mechanisms 12 support the stabilizer bar 3a in a state in which the rotation of the stabilizer bar 3a in the axial circumferential direction is restricted.

As illustrated in FIG. 2, each stabilizer sliding mechanism 12 includes a stabilizer support cylindrical portion 13, an intermediate cylindrical portion 14, and an outer cylindrical portion 15. The stabilizer support cylindrical portion 13 has an inner cylindrical portion 13a and a hard bushing 13b. The outer periphery of the hard bushing 13b is fixed to the inner periphery of the inner cylindrical portion 13a. The hard bushing 13b is a cylinder. The inner periphery of the hard bushing 13b is fixed to the outer periphery of the stabilizer bar 3a. A male screw portion (trapezoidal screw) 13c is formed on the outer periphery of the inner cylindrical portion 13a.

A female screw portion (trapezoidal screw) 14a to be screwed with the male screw portion 13c is formed in the inner periphery of the intermediate cylindrical portion 14. An outer engagement portion 14b is formed in an annular shape on the outer periphery of the intermediate cylindrical portion 14.

The outer periphery of the outer cylindrical portion 15 is fixed to the vehicle body. An inner engagement portion 15a is formed in an annular shape on the inner periphery of the outer cylindrical portion 15. The inner engagement portion 15a is engaged with the outer engagement portion 14b. The engagement between the outer engagement portion 14b and the inner engagement portion 15a allows the intermediate cylindrical portion 14 to axially rotate in a state in which sliding in the axial direction is restricted.

Furthermore, each stabilizer sliding mechanism 12 has a stabilizer drive motor 16. The stabilizer drive motor 16 is, for example, a stepping motor. A drive gear 16a is attached to a motor shaft of the stabilizer drive motor 16. The drive gear 16a is engaged with a driven gear part (not illustrated) formed on the outer periphery of the intermediate cylindrical portion 14. The rotation of the drive gear 16a causes the stabilizer bar 3a to slide to the left and right in the vehicle width direction.

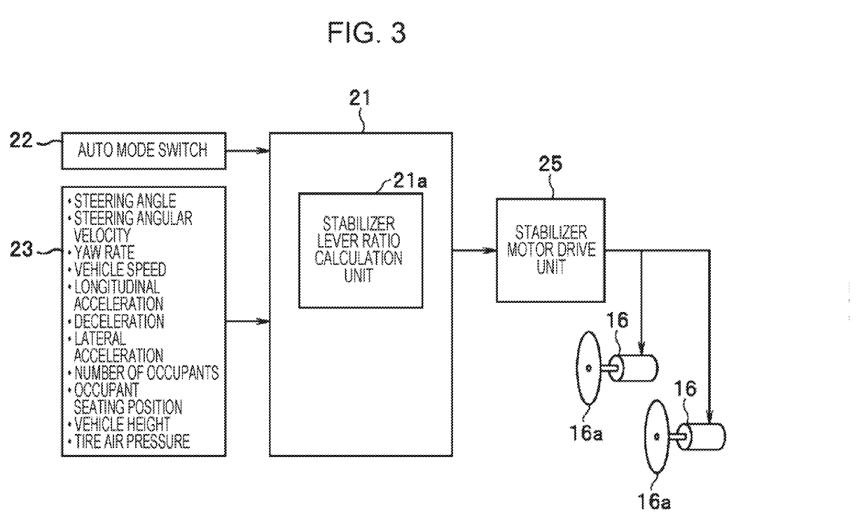

The rotation of each stabilizer drive motor 16 is controlled by a control unit 21 illustrated in FIG. 3. The control unit 21 includes a microcontroller. The microcontroller includes a CPU, RAM, ROM, rewritable nonvolatile memory (flash memory or EEPROM), and peripheral devices. The RAM of the microcontroller is provided as a work area of the CPU, and temporarily stores various data in the CPU. The ROM stores a program, fixed data, and the like necessary for the CPU to execute each process. The CPU is also called a microprocessor (MPU) or a processor. A graphics processing unit (GPU) or a graph streaming processor (GSP) may be used instead of the CPU. Alternatively, the CPU, the GPU, and the GSP may be selectively combined.

An auto mode switch 22 and a parameter detection unit 23 are coupled to the input side of the control unit 21. A stabilizer motor drive unit 25 is coupled to the output side of the control unit 21. The control unit 21 includes a stabilizer lever ratio calculation unit 21a, serving as a controller. The stabilizer lever ratio calculation unit 21a calculates a lever ratio λ for sliding the stabilizer bar 3a toward the left and right wheels 1l and 1r.

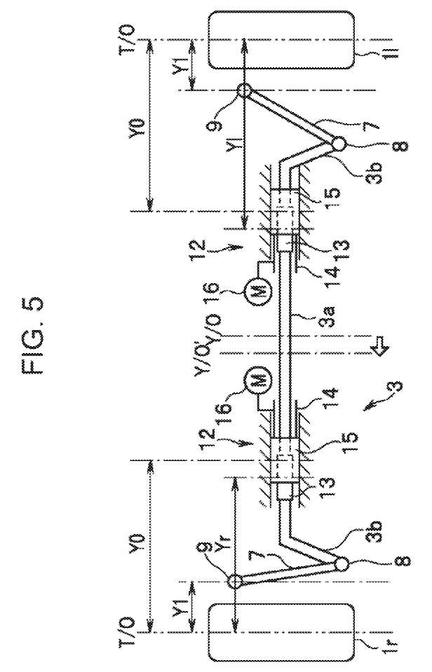

As illustrated in FIGS. 4 and 5, the lever ratio λ is a ratio of a distance (arm distance) Y1 from a ground contact point (in this embodiment, for convenience, the center T/O of the tire width) of the wheel 1r (1l) to the coupling 9 of the stabilizer link 7 on the suspension device 2 side to a distance (stabilizer distance) Yr (or Yl) from the ground contact point to a support point (in this embodiment, for convenience, the center in the axial direction of the stabilizer support cylindrical portion 13) of the stabilizer sliding mechanism 12 (λ = Y1/Yr or λ = Y1/Yl). The arm distance Y1 is substantially fixed. Therefore, the lever ratio λ is a function of the stabilizer distance Yr or Yl.

Furthermore, as illustrated in FIGS. 4 and 5, the distance Y0 when the roll axis G is located at the neutral position is a stabilizer distance (neutral distance) from the ground contact points (T/O) of the wheels 1r and 1l to the support points of the stabilizer sliding mechanisms 12 in a state in which the center (Y/O) of the stabilizer bar 3a coincides with the center of the vehicle M in the vehicle width direction (Y0 = Yl = Yr).

The auto mode switch 22 is operated by a driver. The parameter detection unit 23 is a general term for sensors that detect parameters required when the stabilizer lever ratio calculation unit 21a calculates the lever ratio λ. The parameters detected by the parameter detection unit 23 include a steering angle, a steering angular velocity, a yaw rate, a vehicle speed, a longitudinal acceleration, a deceleration, a lateral acceleration, the number of occupants, occupant seating positions, vehicle height at the front and rear, and a tire air pressure. For example, a change in the inclination of the vehicle body during cornering is estimated based on the number of occupants and the occupant seating positions. The loading weight of the vehicle is estimated based on the vehicle height at the front and rear and the tire air pressure. These parameters may influence a change in the stroke amounts of the left and right suspension devices 2 during cornering of the vehicle M.

When the driver turns on the auto mode switch 22, the stabilizer lever ratio calculation unit 21a is activated. The stabilizer lever ratio calculation unit 21a obtains an optimum lever ratio λ corresponding to the traveling state of the vehicle M during cornering based on the parameters detected by the parameter detection unit 23. The stabilizer lever ratio calculation unit 21a of this embodiment obtains the lever ratio λ of the wheel on the driver's seat side (the right wheel 1r in the case of a right-hand drive vehicle). Alternatively, the stabilizer lever ratio calculation unit 21a may obtain the lever ratio λ on the inside wheel (the right wheel 1r in the case of right turning) side.

The entire stabilizer bar 3a is slid in the vehicle width direction by the stabilizer sliding mechanisms 12. The stabilizer lever ratio calculation unit 21a obtains the lever ratio λ on one wheel 1r (1l) side. As a result, the lever ratio on the other wheel 1l (1r) side is uniquely determined. The stabilizer lever ratio calculation unit 21a may obtain the lever ratio λ of the wheel on the front occupant seat side or the lever ratio on the outside wheel side.

The stabilizer lever ratio calculation unit 21a outputs a drive signal corresponding to the obtained lever ratio λ to the stabilizer motor drive unit 25. The stabilizer motor drive unit 25 synchronously rotates the pair of stabilizer drive motors 16 by a predetermined angle in accordance with the drive signal from the stabilizer lever ratio calculation unit 21a.

Drive gears 16a of the stabilizer drive motors 16 mesh with driven gear parts (not illustrated) formed on the outer peripheries of the intermediate cylindrical portions 14 provided in the stabilizer sliding mechanisms 12.

Here, the operation of the stabilizer sliding mechanisms 12 will be described. When the stabilizer drive motors 16 rotate, the intermediate cylindrical portions 14 rotate via the driven gear parts. The outer engagement portions 14b formed on the outer peripheries of the intermediate cylindrical portions 14 are slidably fitted to the inner engagement portions 15a formed on the inner peripheries of the outer cylindrical portions 15. The outer peripheries of the outer cylindrical portions 15 are fixed to the vehicle body side. Hence, the movement of the intermediate cylindrical portions 14 in the axial direction is restricted, and only the rotation about the axis is allowed.

The female screw portions 14a formed on the inner peripheries of the intermediate cylindrical portions 14 are screwed onto the male screw portions 13c formed on the outer peripheries of the inner cylindrical portions 13a of the stabilizer support cylindrical portions 13. When the intermediate cylindrical portions 14 rotate, the female screw portions 14a feed the stabilizer support cylindrical portions 13 in the axial direction via the male screw portions 13c.

The inner cylindrical portions 13a of the stabilizer support cylindrical portions 13 and the hard bushings 13b are fixed to each other. In addition, the hard bushings 13b are secured to the stabilizer bar 3a. Hence, when the stabilizer support cylindrical portions 13 are fed in the axial direction, the stabilizer bar 3a slides integrally in the same direction.

FIG. 4 illustrates a state in which the center of the stabilizer bar 3a coincides with the center Y/O of the vehicle M in the vehicle width direction. The roll axis G of the vehicle M is set at the center of the stabilizer bar 3a. Furthermore, the stabilizer bar 3a is inclined integrally with the vehicle M. Hence, as illustrated in FIG. 7, when the center of the stabilizer bar 3a and the center Y/O of the vehicle M in the vehicle width direction coincide with each other, the roll axis G is located at the center (Y/O) in the vehicle width direction.

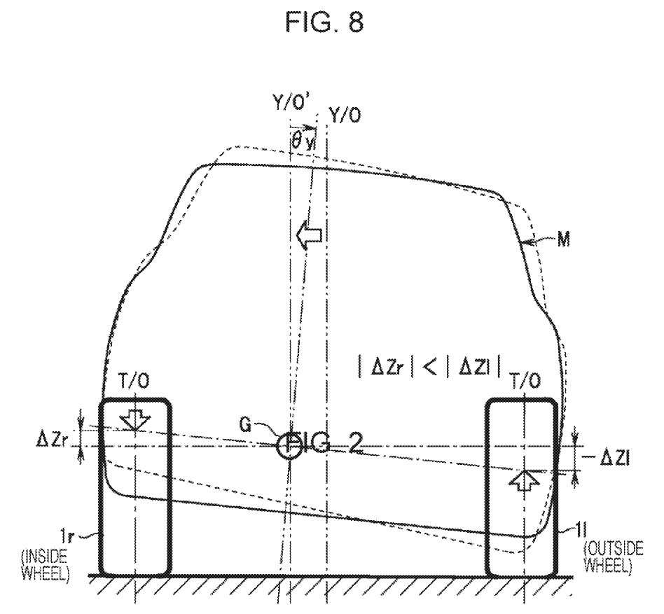

Furthermore, as illustrated in FIG. 5, when the stabilizer bar 3a slides toward the right wheel 1r, the center of the stabilizer bar 3a moves from the center Y/O in the vehicle width direction to Y/O', toward the right wheel 1r. As a result, as illustrated in FIG. 8, the roll axis G is displaced from the center Y/O in the vehicle width direction to Y/O', toward the right wheel 1r.

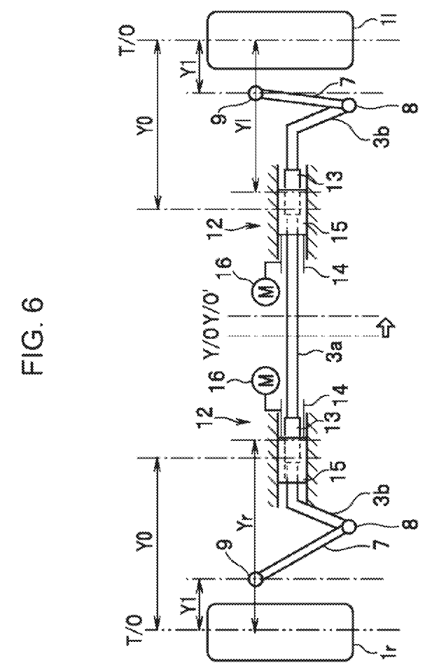

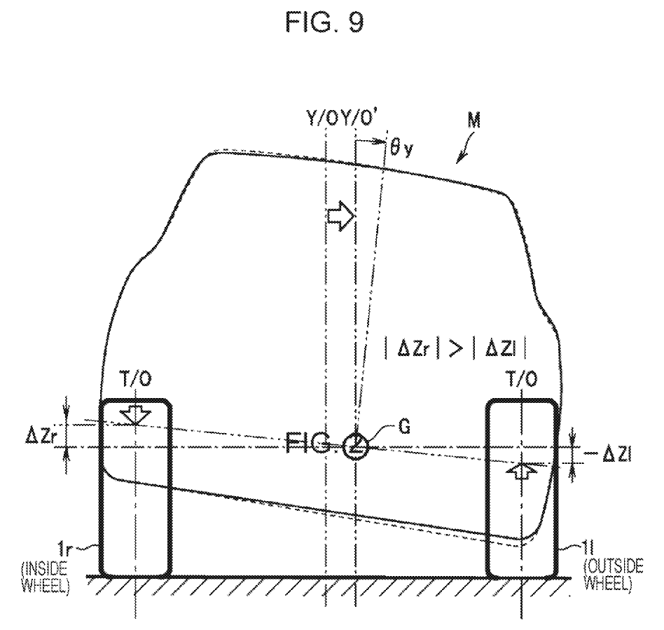

Furthermore, as illustrated in FIG. 6, when the stabilizer bar 3a slides toward the left wheel 1l, the center of the stabilizer bar 3a moves from the center Y/O in the vehicle width direction to Y/O', toward the left wheel 1l. As a result, as illustrated in FIG. 9, the roll axis G is displaced from the center Y/O in the vehicle width direction toward the left wheel 1l by the distance Y/O'.

Next, the operation of the thus-configured embodiment will be described. FIGS. 4 and 7 illustrate an initial state in which the auto mode switch 22 is OFF. In the initial state in which the auto mode switch 22 is OFF, the lever ratio λ is set to an initial value (λ = Y1/Y0). In this state, the center of the stabilizer bar 3a coincides with the center (Y/O) of the vehicle M in the vehicle width direction.

When the driver operates the auto mode switch 22 from ON to OFF, the stabilizer lever ratio calculation unit 21a outputs a drive signal of the lever ratio λ at the initial value (λ = Y1/Y0) to the stabilizer motor drive unit 25 to return the center of the stabilizer bar 3a to the center (Y/O) in the vehicle width direction. In this case, the roll axis G is located at the center (Y/O) in the vehicle width direction (see FIG. 7).

When the vehicle M travels in a state in which the driver turns on the auto mode switch, the stabilizer lever ratio calculation unit 21a checks whether or not the vehicle speed detected by the parameter detection unit 23 is higher than or equal to a preset vehicle speed (for example, 60 [Km/h]). The set vehicle speed is a value used for determining whether or not the lever ratio control is started. Hence, when the vehicle speed of the vehicle M is lower than or equal to the set vehicle speed, the lever ratio λ is fixed to the initial value.

When it is determined that the speed of the vehicle M is higher than the lever ratio control start determination speed, the stabilizer lever ratio calculation unit 21a checks whether the vehicle M is traveling straight, or whether the vehicle is turning to the right or left. The traveling state, i.e., whether the vehicle is traveling straight or turning in any direction, is checked based on one or more of the steering angle, the yaw rate, the lateral acceleration, and the like detected by the parameter detection unit.

Then, the stabilizer lever ratio calculation unit 21a obtains an optimal lever ratio λ of the vehicle M that is currently traveling, based on the steering angular velocity, the yaw rate, the longitudinal acceleration, the number of occupants and the seating positions thereof, the vehicle height at the front and rear and the tire air pressure, which vary depending on the loading weight, detected by the parameter detection unit 23. An optimum displacement amount of the roll axis G is determined based on the lever ratio λ.

The stabilizer lever ratio calculation unit 21a outputs a drive signal corresponding to the obtained lever ratio λ to the stabilizer motor drive unit 25. The stabilizer motor drive unit 25 rotates the pair of stabilizer drive motors 16 in a state of being synchronized by an angle corresponding to the lever ratio λ, in accordance with the drive signal from the stabilizer lever ratio calculation unit 21a.

The intermediate cylindrical portion 14 provided in each stabilizer sliding mechanism 12 is rotated by the rotation of each stabilizer drive motor 16. The outer engagement portions 14b of the intermediate cylindrical portions 14 are engaged with the inner engagement portions 15a of the outer cylindrical portions 15, thus, the movement in the axial direction is restricted, and only the rotation about the axis is allowed.

Hence, when the intermediate cylindrical portions 14 rotate, the stabilizer support cylindrical portions 13 move in the axial direction via the male screw portions 13c screwed into the female screw portions 14a formed in the inner peripheries of the intermediate cylindrical portions 14. The stabilizer bar 3a is integrated with the stabilizer support cylindrical portions 13. Hence, the stabilizer bar 3a slides integrally with the stabilizer support cylindrical portions 13.

Hereinbelow, displacement of the roll axis G caused by the control of the stabilizer lever ratio calculation unit 21a during cornering of the vehicle M will be described. A state in which the vehicle M is turning to the right will be described as an example below. In the case of a left turn, the left and right are reversed.

When the roll axis G is set at the center in the vehicle width direction

As illustrated in FIGS. 4 and 7, when the stabilizer lever ratio calculation unit 21a sets the lever ratio λ to the neutral position, the roll axis G is located at the center (Y/O) in the vehicle width direction.

In this state, as illustrated in FIG. 7, when the vehicle M turns to the right, the suspension device 2 on the right wheel 1r side rebounds, and the suspension device 2 on the left wheel 1l side bumps. As a result, there is a difference between the stroke amounts of the right and left suspension devices 2. A torsional stress is generated in the stabilizer bar 3a due to the difference in stroke between the right and left suspension devices 2.

As a result, as indicated by the white arrows in FIG. 7, restoring forces (reaction forces) for returning the twisting of the stabilizer bar 3a is applied to the left and right suspension devices 2. The roll axis G is located at the center (Y/O) of the vehicle M in the vehicle width direction. Hence, equal (symmetrical) reaction forces in opposite directions are applied to the left and right suspension devices 2.

Hence, a rebound stroke amount (hereinbelow, referred to as a "rebound amount") ΔZr of the suspension device 2 on the right wheel 1r side and a bump stroke amount (hereinbelow, referred to as a "bump amount") -ΔZl of the suspension device 2 on the left wheel 1l side are substantially symmetrical. In other words, the absolute values |ΔZr| = |ΔZl| of the two strokes ΔZr and -ΔZl are substantially equal. The roll angle θy is an inclination corresponding to the rebound amounts ΔZl and ΔZr of the left and right suspension devices 2.

When the roll axis G is displaced to the inside wheel side

As illustrated in FIG. 5, when the stabilizer lever ratio calculation unit 21a sets the lever ratio λ such that the stabilizer distance Yr is shorter than the neutral distance Y0 and closer to the inside wheel (right wheel 1r) side, the stabilizer drive motors 16 slide the stabilizer bar 3a to the right wheel 1r side.

Then, the arm portion 3b on the right wheel 1r side of the stabilizer bar 3a presses one end of the stabilizer link 7 via the ball joint 8. The positional relationship of the stabilizer link 7 with respect to the stabilizer bar 3a and the strut portion of the suspension body is regulated (suspension geometry).

Hence, when the arm portion 3b presses one end of the stabilizer link 7, the stabilizer link 7 axially rotates the strut portion of the suspension body coupled to the other end thereof, or deforms the coupling 9. When the strut portion of the suspension body is axially rotated, or when the coupling 9 is deformed, one end of the stabilizer link 7 approaches the right wheel 1r side. Thus, the stabilizer distance Yr decreases.

Meanwhile, in the stabilizer bar 3a near the left wheel 1l, the arm portion 3b pulls one end of the stabilizer link 7 toward the right wheel 1r via the ball joint 8. Then, the stabilizer link 7 axially rotates the strut portion of the suspension body coupled to the other end thereof, or deforms the coupling 9. As a result, the one end of the stabilizer link 7 moves away from the left wheel 1l, and the stabilizer distance Yl increases (Yr < Y0 < Yl).

As a result, as illustrated in FIG. 5, the center (Y/O') of the stabilizer bar 3a is displaced from Y/O in FIG. 4 toward the right wheel 1r by a distance (Y0-Yr). When the center (Y-O') of the stabilizer bar 3a slides toward the right wheel 1r, as illustrated in FIG. 8, the roll axis G of the vehicle M is also displaced toward the center (Y/O') of the stabilizer bar 3a.

When the vehicle M turns to the right, as illustrated by the solid line in FIG. 8, the suspension device 2 of the right wheel 1r rebounds, and the suspension device 2 of the left wheel 1l bumps. The stabilizer bar 3a is inclined integrally with the vehicle M.

Because the roll axis G is displaced toward the right wheel (inside wheel) 1r, as illustrated in FIG. 8, the reaction force that reduces the rebound amount ΔZr of the suspension device 2 on the right wheel 1r side increases in the stabilizer bar 3a. Relative to this, the reaction force that reduces the rebound amount ΔZl of the suspension device 2 on the left wheel (outside wheel) 1l side decreases in the stabilizer bar 3a. As a result, the rebound amount ΔZr of the suspension device 2 on the right wheel 1r side is reduced, and the rebound amount ΔZl of the suspension device 2 on the left wheel 1l side is increased. Hence, the stroke amounts of the right and left suspension devices 2 are asymmetric (|ΔZr| < |ΔZl|).

The broken line in FIG. 8 indicates the inclination of the vehicle M when the roll axis G illustrated in FIG. 7 is set at the center Y/O of the vehicle M in the vehicle width direction. Here, for ease of description, the bump amount -ΔZl on the outside wheel side (left wheel 1l) is assumed to be equal to that in FIG. 7.

As a result of the roll axis G being displaced to the inside wheel side (right wheel 1r), the rebound amount ΔZr on the inside wheel side is reduced. This enables yawing to be quickly generated, and high response performance to be obtained. Hence, this control is suitable for a sports vehicle or the like having a low vehicle height.

When the roll axis G is displaced to the outside wheel side

As illustrated in FIG. 6, when the stabilizer bar 3a is slid toward the left wheel 1l, the arm portion 3b of the stabilizer bar 3a on the left wheel 1l side presses one end of the stabilizer link 7 via the ball joint 8.

In a suspension geometry, when the arm portion 3b presses one end of the stabilizer link 7, the stabilizer link 7 axially rotates the strut portion of the suspension body coupled to the other end thereof, or deforms the coupling 9. Hence, one end of the stabilizer link 7 approaches the left wheel 1l. As a result, the stabilizer distance Yl decreases.

Meanwhile, the arm portion 3b of the stabilizer bar 3a on the right wheel 1r side pulls one end of the stabilizer link 7 toward the left wheel 1l via the ball joint 8. Then, the stabilizer link 7 axially rotates the strut portion of the suspension body coupled to the other end thereof, or deforms the coupling 9 so as to separate from the right wheel 1r. As a result, the stabilizer distance Yr increases (Yl < Y0 < Yr).

As a result, as illustrated in FIG. 6, the center (Y/O') of the stabilizer bar 3a is displaced from Y/O in FIG. 4 toward the left wheel 1l by a distance (Y0-Yl). When the center (Y-O') of the stabilizer bar 3a slides toward the left wheel 1l, as illustrated in FIG. 9, the roll axis G of the vehicle M is also displaced toward the center (Y/O') of the stabilizer bar 3a.

When the vehicle M turns to the right, as illustrated by the solid line in FIG. 9, the suspension device 2 of the right wheel 1r rebounds, and the suspension device 2 of the left wheel 1l bumps. At this time, the stabilizer bar 3a is inclined integrally with the vehicle M.

At this time, because the roll axis G is displaced to the left wheel 1l side, the reaction force that reduces the bump amount -ΔZl of the suspension device 2 on the left wheel (outside wheel) 1l side increases in the stabilizer bar 3a. Meanwhile, the reaction force that reduces the rebound amount ΔZr of the suspension device 2 on the right wheel (inside wheel) 1r side decreases in the stabilizer bar 3a.

As a result, the bump amount -ΔZl of the suspension device 2 on the left wheel 1l side is reduced, and the rebound amount ΔZr of the suspension device 2 on the right wheel 1r side is relatively increased. As a result, the stroke amounts of the right and left suspension devices 2 are asymmetric (|ΔZr| > |ΔZl|).

The broken line in FIG. 9 indicates the inclination of the vehicle M when the roll axis G illustrated in FIG. 7 is set at the center Y/O of the vehicle M in the vehicle width direction. Here, for ease of description, the bump amount -ΔZr on the inside wheel side (right wheel 1r) is assumed to be equal to that in FIG. 7.

By displacing the roll axis G to the outside wheel side (the left wheel 1l), the bump amount -ΔZl on the outside wheel side is reduced. Even when the rebound amount ΔZr is the same as that in FIG. 7, the understeer (additional steering) amount of the vehicle M during cornering increases due to the bump amount -ΔZl being reduced. As a result, the driver can feel that the vehicle speed is excessive. Therefore, this control is suitable for vehicles having a relatively large vehicle height, such as SUVs or minivans, which turn at a reduced vehicle speed.

As described above, in the present embodiment, because the roll axis is displaced to the inside wheel side or the outside wheel side by sliding the stabilizer bar 3a, the rebound stroke amount on the inner wheel side and the bump stroke amount on the outer wheel side during cornering can be easily made asymmetric by the displacement of the roll axis, according to the characteristics of the vehicle type.

Note that the disclosure is not limited to the above-described embodiment, and for example, the characteristics of the lever ratio λ set by the stabilizer lever ratio calculation unit 21a may be set as desired according to the driver's preference.

According to the disclosure, because the controller drives the stabilizer sliding mechanisms to slide the stabilizer bar and displace the roll axis, the rebound stroke amount on the inner wheel side and the bump stroke amount on the outer wheel side during traveling can be easily made asymmetric according to the characteristics of the vehicle type.

1. A vehicle suspension comprising:
suspension devices configured to support left and right wheels;
a stabilizer bar configured to couple the suspension devices via respective stabilizer links;
a stabilizer sliding mechanism configured to slide the stabilizer bar; and
a controller configured to control driving of a drive unit of the stabilizer sliding mechanism,
wherein the controller is configured to displace a roll axis by sliding the stabilizer bar via the stabilizer sliding mechanism during cornering of a vehicle.

2. The vehicle suspension according to claim 1, wherein a displacement amount of the roll axis is set based on a lever ratio that is a ratio between a distance from a ground contact point of one of the left and right wheels to a coupling of the corresponding stabilizer link with respect to the suspension device and a distance from the ground contact point to the stabilizer sliding mechanism.

3. The vehicle suspension according to claim 2, wherein the controller is configured to detect a turning direction of the vehicle based on one or more of a steering angle, a yaw rate, and a lateral acceleration, and set the lever ratio for displacing the roll axis toward a wheel on an inside of a turn.

4. The vehicle suspension according to claim 2, wherein the controller is configured to detect a turning direction of the vehicle based on one or more of a steering angle, a yaw rate, and a lateral acceleration, and set the lever ratio for displacing the roll axis to a wheel on an outside of a turn.

5. The vehicle suspension according to claim 1, wherein
the stabilizer sliding mechanism comprises a pair of stabilizer sliding mechanisms disposed at bilaterally symmetrical positions with a center in a vehicle width direction of the vehicle therebetween, and
the drive unit is configured to simultaneously drive the stabilizer sliding mechanisms to slide the stabilizer bar.

6. The vehicle suspension according to claim 2, wherein
the stabilizer sliding mechanism comprises a pair of stabilizer sliding mechanisms disposed at bilaterally symmetrical positions with a center in a vehicle width direction of the vehicle therebetween, and
the drive unit is configured to simultaneously drive the stabilizer sliding mechanisms to slide the stabilizer bar.

7. The vehicle suspension according to claim 3, wherein
the stabilizer sliding mechanism comprises a pair of stabilizer sliding mechanisms disposed at bilaterally symmetrical positions with a center in a vehicle width direction of the vehicle therebetween, and
the drive unit is configured to simultaneously drive the stabilizer sliding mechanisms to slide the stabilizer bar.

8. The vehicle suspension according to claim 4, wherein
the stabilizer sliding mechanism comprises a pair of stabilizer sliding mechanisms disposed at bilaterally symmetrical positions with a center in a vehicle width direction of the vehicle therebetween, and
the drive unit is configured to simultaneously drive the stabilizer sliding mechanisms to slide the stabilizer bar.

9. A vehicle suspension comprising:
suspension devices configured to support left and right wheels;
a stabilizer bar configured to couple the suspension devices via respective stabilizer links;
a stabilizer sliding mechanism configured to slide the stabilizer bar; and
circuitry configured to control driving of a drive unit of the stabilizer sliding mechanism,
wherein the controller is configured to displace a roll axis by sliding the stabilizer bar via the stabilizer sliding mechanism during cornering of a vehicle.
